(19) United States
(12) Patent Application Publication
(10) Pub. No.: US 2007/0180746 A1
(43) Pub. Date: Aug. 9, 2007

(54) Photograph label and album page

(76) Inventor: Harold Charles Von Ohsen, Tybee Island, GA (US)

Correspondence Address: Harold C. Von Ohsen, 138 San Marco Drive, Tybee Island, GA, 31328, US

(21) Appl. No.: 11/350,239

(22) Filed: Feb. 8, 2006

(51) Int. Cl. G09F 3/10

(52) U.S. Cl. 40/638

(57) ABSTRACT

A label (10) for identifying a photograph (12) or like item, comprising a backing sheet (15) with a first zone of adhesive (16) and a second zone of adhesive (18), both applied to one face of the backing sheet, and an indicia-bearing strip (19) attached to the backing sheet by the second zone of adhesive. The user can attach the photograph adjacent to the indicia-bearing strip, utilizing the first zone of adhesive. Other embodiments of the invention include a kit comprising labels and single or multiple-picture album pages, (29) or (33) respectively. The album pages contain oversized sleeves (28) to display and protect labeled photographs. The oversized sleeves are designed to accept labeled photographs regardless of whether the label is attached to either a long side (14) or a short side (13) of the photograph.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to methods of identifying and displaying photographs and the like. It is frequently desirable to include identifying information with photographic prints such as the subject, place, date, etc. of the photograph. Several methods have previously been used for this purpose, with marginal success.

One method is to annotate the back of the photograph with identifying information using a marking pen. This method has several disadvantages. First the force of writing on the back of the photograph can cause damage to the face of the photograph. Second the inks used in some marking pens can damage the photograph. Another major disadvantage of this method is that when the photograph is mounted in an album or frame, the identifying information is no longer visible.

Another method for identifying photographs consists of writing identifying information directly on to the page on which the photograph is mounted. U.S. Pat. No. 2,296,272 dated Sep. 22, 1942 issued to W. N. De Sherbinin discloses this method. This method has the advantage that the photograph and its identifying data may be simultaneously viewed; however there are several disadvantages. First, if the photograph is removed from the album for better viewing, it loses its identifying data. Second, if the user wants to relocate photographs from one position in the album to another after the album is complete, the photograph's identifying data must be erased (if possible) and also relocated. This is because the identifying data is written directly on the album page.

A third alternative of identifying photographs is disclosed in U.S. Pat. No. 4,736,536 dated Apr. 12, 1988 issued to Henry V. Doman. This patent describes a method that uses an envelope that is slipped over the side or end of the photograph and attached with adhesive to the rear of the photograph. Identifying data may be placed on the front of the envelope. This method has several advantages. One advantage is that the identifying data is attached to each photograph providing identification even when the photograph is not subsequently placed in a photo album or frame. If the identified photograph is placed in an album, each photograph along with its identifying data may be readily relocated in the album. This is because the identifying data is attached to each photograph and not the album page.

However, there also are several disadvantages to this method. One major disadvantage, when used in its preferred arrangement, is the envelope conceals a portion of the photograph. The portion of the photograph that is inside the envelope is hidden from view.

A second disadvantage is that the envelope system adds two layers of material, including two bent-over tabs, to the back of the photograph and one layer of material to the front. The two layers on the back and especially the tabs will likely cause the label to become detached from the photograph when a stack of photographs are handled for viewing. If the labeled photographs are mounted in a photo album with adhesive faced pages, adhesive corners, or double faced adhesive tape, the two layers on the back and especially the bent-over tabs will prevent the labeled photographs from lying flat on the page. Normal handling by the user will tend to detach the labeled photographs from the album.

In addition, another disadvantage of this method is that labeled photographs can not be placed in some types of photo albums designed for unlabeled photographs. Sleeve and pocket type photo album sheets are generally designed to hold standard size photographs with a snug fit. Adding a label to either the short side or the long side of the photograph would generally cause the combination to no longer fit in a standard size sleeve or pocket.

### BRIEF SUMMARY OF THE INVENTION

Accordingly, several objects and advantages of the present invention are:
(a) to provide a label for photographs and like items that is securely attached to the photograph,
(b) to provide a label that can be removed, repositioned or replaced without damaging the photograph or the label,
(c) to provide a label that in no way obscures a portion of the photograph,
(d) to provide a label that is self-aligning and easy to apply,
(e) to provide a label that is simple and inexpensive to manufacture,
(f) to provide a label that allows identifying information to be applied by pen or pencil,
(g) to provide a label that allows identifying information to be printed on the label with a printer or typewriter,
(h) to provide a label that allows mounting labeled photographs in a photo album with adhesive faced pages, adhesive corners, or double faced adhesive tape and not become detached by normal handling because the labeled photographs lie substantially flat on the page,
(i) to provide a label where there is a minimum of layers (and no tabs) added, so that labeled photographs may be stacked and handled for viewing without dislodging the labels, and
(j) to provide album pages with over-sized sleeves that are large enough to enclose photographs with a label applied to either the short side or the long side of the photograph.

Still further objects and advantages will become apparent from a consideration of the ensuing description and drawings.

### REFERENCE NUMERALS IN DRAWINGS

10 label
11 layered assembly
12 photograph
13 short side
14 long side
15 backing sheet
16 first zone of adhesive
17 protective strip
18 second zone of adhesive
19 indicia-bearing strip
20 sheet of layered assemblies
22 folded label
24 lamina
25 backing area
26 indicia-bearing area
27 fold line
28 sleeve
29 single-picture album page
30 transparent sheet
31 opaque sheet
32 seal
33 multiple-picture album page

### BRIEF DESCRIPTION OF THE SEVERAL VIEWS OF THE DRAWING

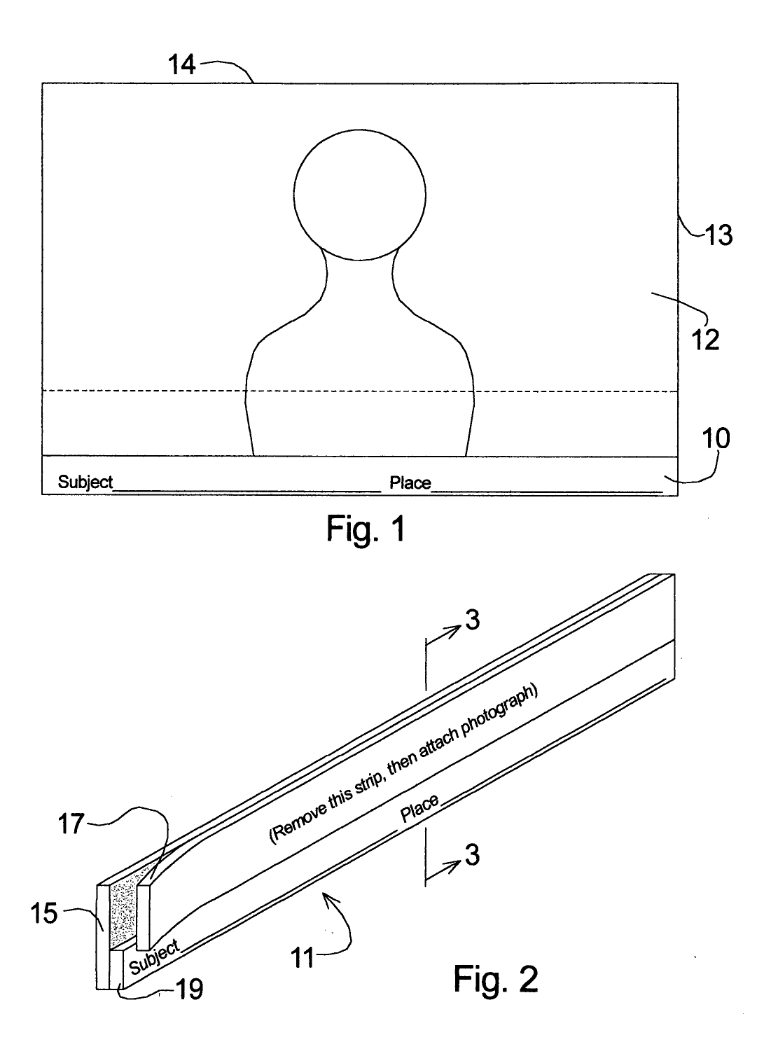

FIG. 1 shows the label applied to the long side of the photograph.

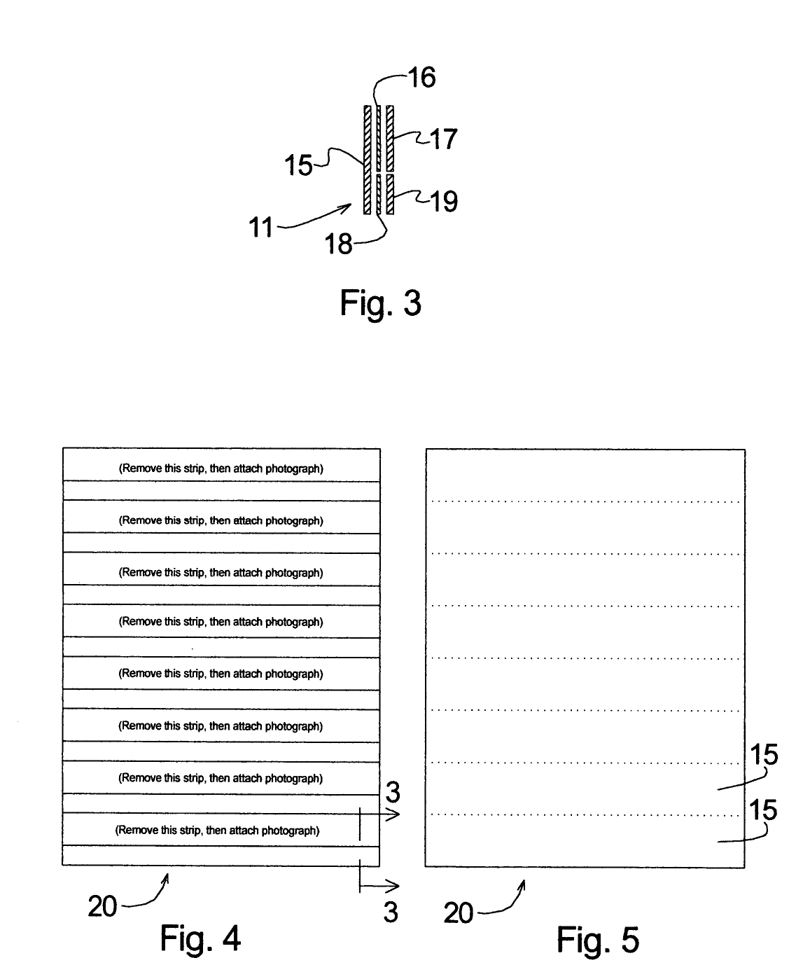

FIGS. 2 and 3 show the details of the layered assembly, before attachment to the photograph.

FIG. 4 shows the front view of the sheet of layered assemblies, juxtaposed horizontally.

FIG. 5 shows the rear view of the same sheet of layered assemblies in FIG. 4, detailing the horizontal perforations.

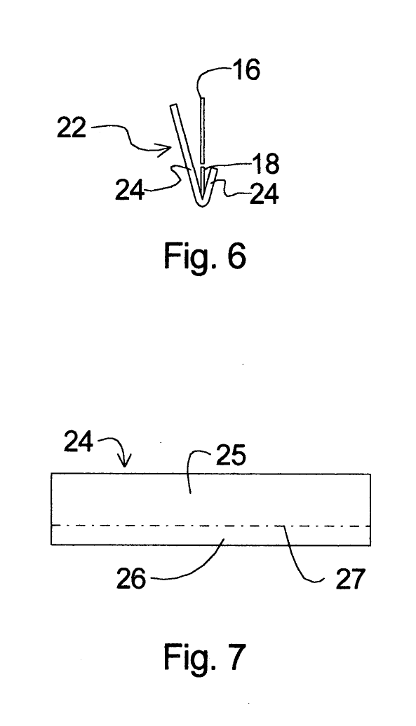

FIGS. 6 and 7 shows the details of the folded label.

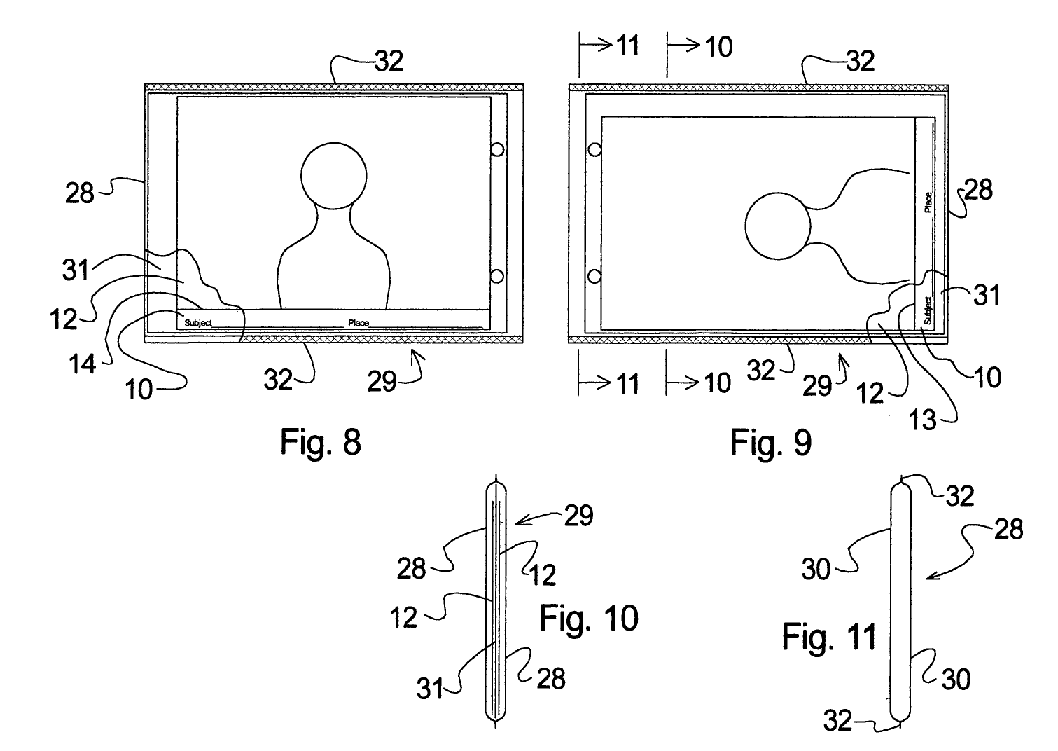

FIG. 8 shows the rear view of the single-picture album page, containing a single labeled photograph.

FIG. 9 shows the front view of the single-picture album page, containing a single labeled photograph.

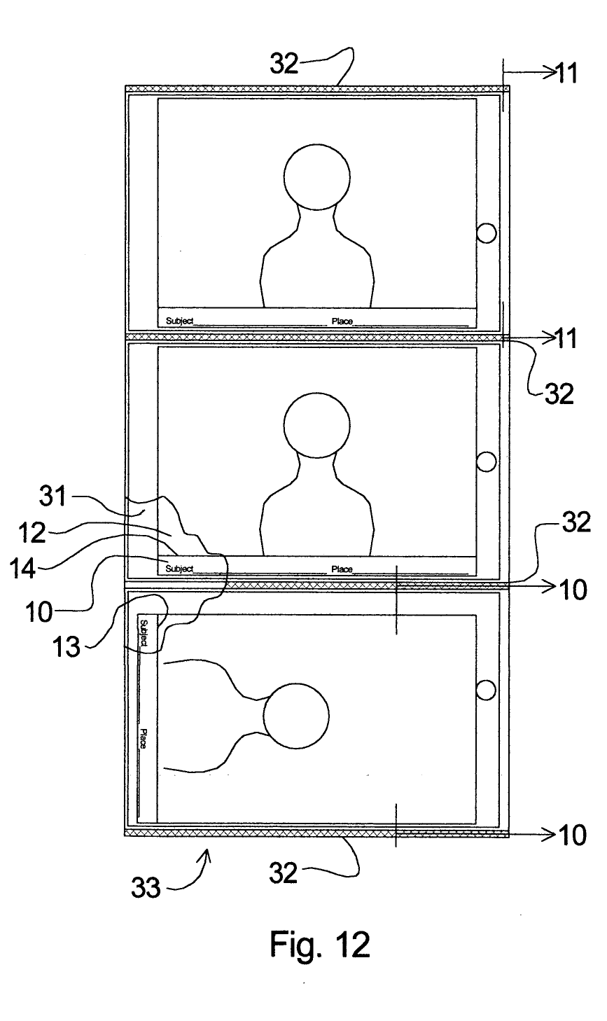

FIG. 10 shows a section view of the album pages in FIGS. 9 and 12.

FIG. 11 shows another section view of FIGS. 9 and 12, detailing how the sleeve is constructed.

FIG. 12 shows the rear view of the multiple-picture album page, containing three labeled photographs.

FIG. 1-3 Description of Layered Assembly

FIG. 1 shows a label 10 applied to a long side 14 of a photograph 12. Label 10 is formed when a protective strip 17 is removed from a layered assembly 11, as shown in FIG. 2. Label 10 shown in FIG. 1 is oriented for attachment to the bottom of long side 14 of photograph 12. It is to be understood that label 10 could also be attached to the top of long side 14 or to either the left or right of a short side 13 of the photograph.

In the ensuing description, various embodiments of label 10 are shown with photograph 12. However, it is to be understood that label 10 may also be used to identify the myriad items found in the home or office which are amenable to receiving a flat label, such as post cards, photo identification badges, invoices, or other papers, for examples.

FIGS. 2 and 3 show the details of the preferred embodiment. Layered assembly 11 is formed by attaching a protective strip 17 and an indicia-bearing strip 19 to a backing sheet 15 with two adhesive zones. FIG. 3 shows, most clearly, the two zones of adhesive. A first zone of adhesive 16 attaches protective strip 17 to backing sheet 15. A second zone of adhesive 18 attaches indicia-bearing strip 19 to backing sheet 15.

In the preferred embodiment, first zone of adhesive 16 is applied to backing sheet 15. The adhesive used is a pressure-sensitive type that allows label 10 to be removed, repositioned or replaced at will, without damage to the photograph or the label.

Protective strip 17 is attached over first zone of adhesive 16 to protect the adhesive area from damage until the label is used and to prevent labels from sticking together. The front of protective strip 17 may be blank or may be pre-printed with instructions, such as “Remove this strip, then attach photograph”. Protective strip 17 is removed and discarded before applying label 10 to a photograph or like item.

In the preferred embodiment, second zone of adhesive 18 is alternatively applied to either backing sheet 15 or to indicia-bearing strip 19. In the preferred embodiment, second zone of adhesive 18 is a permanent adhesive to provide a tight and permanent attachment between backing sheet 15 and indicia-bearing strip 19.

The accessible face of indicia-bearing strip 19 may be blank or printed with titles such as subject, place, date, etc. Also, guidelines may be printed on indicia-bearing strip 19 to guide free hand entering of identifying information on the label. Indicia-bearing strip 19 is made of a material that readily accepts ink, pencil, printer or typewriter annotations.

Indicia-bearing strip 19 is preferably about ten millimeters (about three-eighths inch) wide (the vertical dimension in FIG. 1-3) to allow a convenient amount of space for one hand written line of annotations about the photograph. Optionally, indicia-bearing strip 19 could be made wider to accommodate several lines of annotations about the photograph. The length of indicia-bearing strip 19 is predetermined to be equal to or longer than the length of the side of the photograph to which the label will be applied.

FIG. 1-3 Operation of Layered Assembly

To identify a photograph 12 or like item with layered assembly 11, first indicia-bearing strip 19 is annotated with identifying information about the photograph such as the subject, place, date, etc. The annotations may be made by hand with a pencil or pen or with a typewriter or printer.

Then, protective strip 17 is removed from layered assembly 11 and discarded. Label 10, created by removing protective strip 17, is placed on a flat surface with the annotated face of indicia-bearing strip 19 facing up. Label 10 is held down on the flat surface with two fingers of one hand placed over indicia-bearing strip 19. The photograph is held in the other hand. Referring now to FIG. 1, the (right or left) edge of the photograph and label are aligned. Then, using the top edge of indicia-bearing strip 19 for alignment in the vertical direction, the photograph is pressed down along the label. This secures the photograph to the label along first zone of adhesive 16.

Referring now to FIGS. 1 and 2, the top edge of indicia-bearing strip 19 provides a convenient guide for alignment in the vertical direction. The (left or right) edge of the photograph and label provide a convenient guide for alignment in the horizontal direction. Furthermore, because of the type adhesive used in first zone of adhesive 16, label 10 may be removed and realigned, if needed, without damaging the photograph or the label.

Also, if the label is long enough for long side 14 of the photograph, it may be trimmed with scissors or the like to fit short side 13. In this manner, labels of one length can be used to identify photographs with the label applied to any side.

FIG. 1-3 Description and Operation of Simplified Layered Assembly

In a second embodiment, both first zone of adhesive 16 and second zone of adhesive 18 are made from the same pressure-sensitive adhesive that allows the joined surfaces to be parted, repositioned and rejoined at will, without damage to the surfaces. This may reduce manufacturing costs over using two different adhesives. Layered assembly 11 produced in this manner would not have as tight a bond between indicia-bearing strip 19 and backing sheet 15 as in the preferred embodiment. Otherwise, the description and operation of this embodiment is the same as the preferred embodiment.

FIG. 1-3 Description and Operation of Permanent-Adhesive Layered Assembly

A third embodiment is to use a pressure-sensitive adhesive that eventually cures to form a permanent bond for first zone of adhesive 16. In this embodiment, protective strip 17 would have an adhesive repelling coating on its rear surface so that the strip can be easily removed before attaching label 10 to a photograph.

This embodiment would provide a more permanent attachment between the label and the photograph. This may be more desirable in some applications. For example, in a photo identification badge application, permanent attachment between the photograph and the label may be desired to prevent tampering with the photo identification badge at a later time. Otherwise, the description and operation of this embodiment is the same as the preferred embodiment.

FIG. 3-5 Description and Operation of Sheet of Layered Assemblies

A fourth embodiment, to allow the user to more easily add identifying information to layered assemblies 11 using a printer or typewriter, is shown in FIG. 3-5. A sheet of layered assemblies 20 is formed by juxtaposing and attaching a plurality of layered assemblies 11 along the edges of backing sheet 15. The edges of backing sheet 15 are attached to one another along perforations as illustrated in FIG. 5.

To prepare sheet of layered assemblies 20 for use, identifying information is printed on indicia-bearing strips 19 with a typewriter or printer. Then, the sheet of layered assemblies 20 is torn along the perforations to from a plurality of layered assemblies 11. Otherwise, the description and operation of this embodiment is the same as the preferred embodiment.

Although a single column of layered assemblies 11 is shown juxtaposed horizontally in FIG. 4, it should be understood that myriad other arrangements are also possible. Other arrangements include more than one column of labels on one sheet. A particularly desirable arrangement would be to have two different label lengths on a single sheet. One of the two lengths would be for printing labels for the short side of the photograph and the other width would be for printing labels for the long side of the photograph.

FIG. 6-7 Description and Operation of Folded Label

A fifth embodiment, a folded label 22, is shown from the side in FIG. 6. A single rectangular lamina 24 is used in this embodiment to replace the separate backing sheet 15 and indicia-bearing strip 19 used in the preferred embodiment.

FIG. 7 shows lamina 24 before folding. The long dimension of lamina 24 is equal to or greater than the length of the side of the photograph to which it will be applied. The lamina contains two rectangular areas, a backing area 25 and a smaller indicia-bearing area 26. Indicia-bearing area 26 is preferably about ten millimeters (about three-eighths inch) wide (the vertical dimension in FIG. 7) to allow a convenient amount of space for one hand written line of annotations about the photograph. Optionally, indicia-bearing area 26 could be made wider to accommodate several lines of annotations about the photograph.

A first zone of adhesive 16 is applied to backing area 25. A second zone of adhesive 18 is applied to indicia-bearing area 26 or, optionally, to backing area 25, below the first zone of adhesive. Indicia-bearing area 26 is folded over, along a fold line 27, shown in FIG. 7, and joined to backing area 25 by second zone of adhesive 18, as shown in FIG. 6. This creates a folded label 22, substantially the same as label 10 described in the preferred embodiment.

The adhesive used for first zone of adhesive 16 is a pressure-sensitive type that allows folded label 22 to be removed, repositioned or replaced at will, without damage to the photograph or the folded label. This same adhesive may be used for second zone of adhesive 18 or, optionally, a more permanent adhesive may be used to form a tight and permanent attachment between backing area 25 and indicia-bearing area 26.

Optionally, a protective strip 17 (not shown) may be applied over first zone of adhesive 16 to protect the adhesive until folded label 22 is used. The front of protective strip 17 may be blank or may be pre-printed with instructions, such as “Remove this strip, then attach photograph”. Protective strip 17 is removed and discarded before applying label 10 to a photograph or like item.

The accessible face (after folding) of indicia-bearing area 26 may be blank or printed with titles such as subject, place, date, etc. Also, guidelines may be printed on the accessible face of indicia-bearing area 26 to guide free hand entering of identifying information on the label. Lamina 24 is made of a material that readily accepts ink, pencil, printer or typewriter annotations.

This embodiment may be less expensive to manufacture, since fewer parts are used. Otherwise, the description and operation of this embodiment is the same as the preferred embodiment.

FIG. 8-11 Description of Single-Picture Album Page

A sixth embodiment, FIG. 8-11, shows a kit containing both labels 10 and a single-picture album page 29 designed to protect and display labeled photographs. FIG. 8 shows the rear view of single-picture album page 29 containing a photograph 12 with label 10 installed on long side 14 of the photograph. FIG. 9 shows the front view of single-picture album page 29 containing a photograph 12 with label 10 installed on short side 13 of the photograph.

FIG. 9 and section view, FIG. 11, shows the details of construction of a flat rectangular sleeve 28 formed by sealing together two sheets of transparent material 30 with seals 32. Seals 32 are preferably heat seals, but may alternatively be made with adhesive.

FIG. 10 shows a section view of single-picture album page 29 and details of construction. FIG. 10 shows how sleeve 28 accepts two photographs 12 with an opaque sheet 31 in between the two. One photograph would face towards the front of the page as shown in FIG. 9 and the other photograph would face towards the rear of the page as shown in FIG. 8. Opaque sheet 31 is intended to enhance the display of the photographs on each face of the album page by providing a solid background. The opaque sheet could optionally be omitted to reduce costs.

Referring now to FIG. 8, the vertical dimension of the album page is predetermined to allow photograph 12 with label 10 installed on long side 14 of the photograph, to be inserted into sleeve 28 with a snug fit. Referring now to FIG. 9, the horizontal dimension of the album page is predetermined so that photograph 12, with label 10 installed on short side 13 of the photograph, will be fully covered and protected by sleeve 28. Furthermore, all single-picture album pages 29 have the same horizontal and vertical dimensions. Therefore, photographs 12, with labels 10 installed either on short side 13 or long side 14, may be inserted into either side of sleeve 28 of any single-picture album page 29.

Although FIG. 8-9 show single-picture album page 29 with holes for ring or post binding within a photo album, it should be understood that there could be other means utilized such as heat sealed bindings, ultrasonically welded bindings, spiral bindings, etc. Although FIG. 8-9 show photographs 12 with labels 10 according to the preferred embodiment, folded labels 22 described above could be substituted for labels 10. If this were done, the description of single-picture album page 29 would be the same.

FIG. 8-11 Operation of Single-Picture Album Page

First, photographs 12 are labeled as described above for the preferred embodiment. Then the labeled photographs are simply inserted into the front and rear of sleeve 28 on each single-picture album page 29. Labeled photographs with labels 10 on the long side are placed in the album page as shown in FIG. 8. Labeled photographs with labels 10 on the short side are placed in the album page as shown in FIG. 9. In either case, sleeve 28 protects both the photograph and the label. Finally, single-picture album pages 29 may be assembled into a photo album by binding the sheets together with rings, posts, heat seals, etc. and optionally adding an album cover.

Although FIG. 8-9 show photographs 12 with labels 10 according to the preferred embodiment, folded labels 22 described above could be substituted for labels 10. If this were done, the operation of single-picture album page 29 would be the same.

FIG. 8-12 Description and Operation of Multiple-Picture Album Page

A seventh embodiment, which is shown in FIG. 8-12, is a kit containing labels 10 and multiple-picture album pages 33. This embodiment allows the user to insert multiple labeled photographs on the face of a single page. FIG. 12 shows one possible arrangement. Three labeled photographs are inserted into the face of multiple-picture album page 33. Multiple-picture album page 33 is constructed by juxtaposing and attaching a plurality of single-picture album pages 29 at seals 32, as shown in FIG. 12. Seals 32 are preferably heat seals but may also made with adhesive.

In addition to the arrangement shown in FIG. 12, it should be understood that numerous other arrangements are also possible. For example, any number of pictures could be displayed on the face of a single page. Some, or all, of the sleeves could have a greater vertical distance between seals 32 than is shown in FIG. 12 to allow upright display of photographs, with labels 10 installed along the short side 13. (The lowest photograph in FIG. 12 is not displayed upright.) Although FIG. 12 shows multiple-picture album page 33 with holes for ring or post binding within a photo album, it should be understood that there could be other means utilized such as heat sealed bindings, ultrasonically welded bindings, spiral bindings, etc.

The operation of this embodiment is the same as the previous embodiment. FIG. 12 illustrates how the user may insert and protect photographs 12, with labels 10 installed either on the long side or the short side, in any of the three positions on the page.

Although FIG. 10-12 show photographs 12 with labels 10 according to the preferred embodiment, folded labels 22 described above could be substituted for labels 10. If this were done, the description and operation of multiple-picture album page 33 would be the same.

Ramifications and Scope

Accordingly, the reader can see that the label of this invention provides an easy to manufacture and easy to use method of identifying photographs and like items, without damage to the photograph, and without obscuring a portion of the photograph.

This invention describes labels that are securely attached to the photographs, allowing individual and stacks of photographs to be handled and viewed without dislodging the labels. However, the labels may be removed, repositioned and replaced by the user, without damaging the photograph or the label.

The labeled photographs may be placed in photo albums with adhesive faced pages, adhesive corners, or double-faced adhesive tape and lie substantially flat so as not to be easily dislodged. Since the label is attached to the photograph, no re-labeling effort is required if the user rearranges the labeled photographs in the album at a later time.

Several alternate embodiments are described:

(a) to show how the labels may be manufactured with less expense,

(b) to create labels in sheet form to allow the labels to be more easily annotated with a printer or typewriter, and

(c) to affix the label to the photograph with permanent adhesive for special uses, such as for photo identification badges.

Further, this invention describes kits containing labels and album pages to protect and display labeled photographs. The design allows labeled photographs to be inserted into any position on any page, regardless if the label is on the long side or the short side of the photograph.

While my above description contains many specificities, these should not be construed as limitations on the scope of the invention, but rather as exemplification of one preferred embodiment thereof. Many other variations are possible. For example:
(a) the label can be made from paper, plastic sheet material, fabric, or other sheet materials;
(b) the label can be made in any color the user desires;
(c) the label can have preprinted words, lines, symbols, advertisements, etc. placed on the indicia-bearing strip or area;
(d) if the optional protective strip is omitted, the labels could be stacked on top of each other in various ways that would protect the adhesive area until the label is removed from the stack;
(e) the first zone of adhesive may optionally fill the entire area behind the protective strip or only partially fill the area to reduce adhesive costs,
(f) the second zone of adhesive may optionally fill the entire area behind the indicia-bearing strip or only partially fill the area to reduce adhesive costs.

Thus the scope of the invention should be determined by the appended claims and their legal equivalents, rather than the examples given.

I claim:

1. A label for identifying a photograph or like item, said label comprising:
a backing sheet with a first zone of adhesive and a second zone of adhesive, both applied to one face of said backing sheet,
an indicia-bearing strip with a length equal to or greater than the length of the side of said photograph to which said label will be applied,
said indicia-bearing strip having a predetermined width, and
said indicia-bearing strip attached to said backing sheet by said second zone of adhesive,
whereby a human may attached said label to said photograph using said first zone of adhesive.

2. The label of claim 1, further including a protective strip applied over said first zone of adhesive, whereby said first zone of adhesive is protected until said protective strip is removed.

3. The label of claim 1, wherein the adhesive in said first zone of adhesive is of a type that allows said label to be removed, repositioned or replaced without damage to either said label or said photograph.

4. The label of claim 1, wherein the accessible surface of said indicia-bearing strip comprises a writing surface on which identifying data may be written.

5. The label of claim 4, wherein the accessible surface of said indicia-bearing strip includes pre-printed indicia and guidelines for identifying the subject and place of said photograph.

6. The label of claim 1, further including a plurality of said backing sheets, juxtaposed and attached along perforations, whereby a sheet of said labels is formed that may have identifying indicia applied by a printer or a typewriter and then separated along the perforations to form individual said labels.

7. The label of claim 1, further including a single-picture album page comprising:
a rectangular transparent flat sleeve,
said sleeve having a long side and a short side,
said short side of said sleeve having a predetermined dimension that allows said photograph, with said label applied along the long side of said photograph, to slide into said sleeve with a snug fit, and
said long side of said sleeve having a predetermined dimension that allows said sleeve to fully cover said photograph, with said label applied along the short side of said photograph, inside said sleeve,
whereby a kit is formed including both said labels and said single-picture album pages with said sleeves that will accommodate one labeled photograph on each face of each page.

8. The label and single-picture album page of claim 7, further including a multiple-picture album page comprising a plurality of said single-picture album pages, juxtaposed and attached along one or more edges of said single-picture album pages, whereby a kit is formed including both said labels and said multiple-picture album pages with said sleeves that will accommodate multiple labeled photographs on each face of each page.

9. A folded label for identifying a photograph or like item, said folded label comprising:
a rectangular lamina with a long side and a short side,
said long side with a length equal to or greater than the length of the side of said photograph to which said folded label will be applied,
said lamina divided into two rectangular areas by a fold line, parallel to said long side, to form a rectangular backing area and a smaller rectangular indicia-bearing area,
said lamina with a first zone of adhesive and a second zone of adhesive, both applied to one face of said lamina,
said lamina having said indicia-bearing area folded over along said fold line and joined to said backing area with said second zone of adhesive,
whereby a human may attached said folded label to said photograph using said first zone of adhesive.

10. The folded label of claim 9, further including a protective strip applied over said first zone of adhesive, whereby said first zone of adhesive is protected until said protective strip is removed.

11. The folded label of claim 9, wherein the adhesive in said first zone of adhesive is of a type that allows said label to be removed, repositioned or replaced without damage to either said label or said photograph.

12. The folded label of claim 9, wherein the accessible face of said indicia-bearing area comprises a writing surface on which identifying data may be written.

13. The folded label of claim 12, wherein the accessible face of said indicia-bearing area includes pre-printed indicia and guidelines for identifying the subject and place of said photograph.

14. The folded label of claim 9, further including a single-picture album page comprising:
a rectangular transparent flat sleeve,
said sleeve having a long side and a short side,
said short side of said sleeve having a predetermined dimension that allows said photograph, with said folded label applied along the long side of said photograph, to slide into said sleeve with a snug fit,
said long side of said sleeve having a predetermined dimension that allows said sleeve to fully cover said photograph, with said folded label applied along the short side of said photograph, inside said sleeve,
whereby a kit is formed including both said folded labels and said single-picture album pages with said sleeves that will accommodate one labeled photograph on each face of each page.

15. The folded label and single-picture album page of claim 14, further including a multiple-picture album page comprising a plurality of said single-picture album pages, juxtaposed and attached along one or more edges of said single-picture album pages, whereby a kit is formed including both said folded labels and said multiple-picture album pages with said sleeves that will accommodate multiple labeled photographs on each face of each page.
